(19) United States
(12) Patent Application Publication
(10) Pub. No.: US 2018/0158569 A1
(43) Pub. Date: Jun. 7, 2018

(54) ELECTRIC WIRE WITH TERMINAL, METHOD FOR MANUFACTURING ELECTRIC WIRE WITH TERMINAL AND WIRE HARNESS

(71) Applicant: Yazaki Corporation, Tokyo (JP)

(72) Inventors: Tomokazu Yoshida, Susono-shi (JP); Kenji Osada, Susono-shi (JP)

(73) Assignee: Yazaki Corporation, Tokyo (JP)

(21) Appl. No.: 15/831,550

(22) Filed: Dec. 5, 2017

(30) Foreign Application Priority Data
Dec. 6, 2016 (JP) 2016-236739

(51) Int. Cl. H01B 7/282; H01B 5/12; H01R 4/18; H01R 4/62; H01R 4/70; H01R 43/00; H01R 43/048

(52) U.S. Cl. CPC H01B 7/282; H01B 5/12; H01R 4/185; H01B 1/023; H01R 4/70; H01R 43/005; H01R 43/048; H01R 4/62

(57) ABSTRACT

An electric wire with a terminal includes an electric wire, a terminal electrically connected to the electric wire, and a protective layer covering a connecting part between the electric wire and the terminal. The terminal is made of a material different from a material of a conductor of the electric wire in the connecting part. The protective layer includes a water repellent layer having a fine concave-convex structure formed by aggregates of fine particles on a surface layer thereof and having a contact angle to water of 150° or larger.

### CROSS REFERENCE TO RELATED APPLICATIONS

This application claims priority from Japanese Patent Application No. 2016-236739 filed on Dec. 6, 2016, the entire contents of which are incorporated herein by reference.

### BACKGROUND OF THE INVENTION

### Field of the Invention

The present invention relates to an electric wire with a terminal, a method for manufacturing an electric wire with a terminal, and a wire harness.

### Description of Related Art

An electric wire with a terminal comprising an electric wire and a terminal provided at the end of the electric wire is conventionally used as a wire harness for an automobile. Regarding an electric wire with a terminal of this type, it is proposed to use an electric wire using aluminum as a conductor (aluminum electric wire). The aluminum electric wire is light in weight and low in cost as compared with the case of using copper as a conductor, but corrosion of a conductor (so-called galvanic corrosion) may be sometimes generated when a liquid has attached to a connecting part between a conductor and a terminal due to the difference in spontaneous potential between a material used in a terminal (for example, copper) and aluminum.

For the same reason as above, even in the case where an aluminum electric wire is not used, when a material constituting a conductor of an electric wire differs from a material constituting a terminal (that is, dissimilar metal connection), galvanic corrosion may sometimes occur in the connecting part between a conductor and a terminal.

In view of the above, in one of the conventional electric wires with a terminal (hereinafter referred to as “the conventional product”), a sealing material for water cutoff such as a silicone rubber is previously provided on an inner surface of a terminal, and a terminal and a conductor are press bonded to each other so as to surround the whole of a connecting part between the conductor and the terminal by the sealing material for water cutoff. By this, the conventional product prevents an electrolytic solution or the like from entering a connecting part between a conductor and a terminal, and prevents corrosion in the connecting part (see Patent Document 1: JP-A-2013-80682).

### [Patent Document 1] JP-A-2013-80682

According to a related art, it is in principle difficult to decrease a thickness of the sealing material for water cutoff from the standpoint of securing sufficient water cutoff properties. For this reason, a size of the terminal itself is increased (thickened) due to a thickness of the sealing material for water cutoff, and as the case may be, there is a possibility that a terminal is difficult to be attached to an object to which a terminal is attached (for example, cavity of a connector). In other words, in the conventional product, corrosion resistance of a connecting part between a conductor of an electric wire and a terminal is enhanced, but there is a possibility that adaptability to an object to which a terminal is attached is impaired.

### SUMMARY

One or more embodiments provide an electric wire with a terminal that can prevent corrosion in a connecting part between a conductor of an electric wire and a terminal while maintaining adaptability to an object to which a terminal is attached, a method for manufacturing an electric wire with a terminal, and a wire harness.

According to the aspect (1), an electric wire with a terminal includes an electric wire, a terminal electrically connected to the electric wire, and a protective layer covering a connecting part between the electric wire and the terminal. The terminal is made of a material different from a material of a conductor of the electric wire in the connecting part. The protective layer includes a water repellent layer having a fine concave-convex structure formed by aggregates of fine particles on a surface layer thereof and having a contact angle to water of 150° or larger.

In an aspect (2), the conductor of the electric wire may be made of copper, aluminum or an aluminum alloy. The terminal may include a base material made of copper or a copper alloy, and a plating layer made of tin, gold or silver formed on a surface of the base material.

According to the aspect (1), a connecting part between a conductor of an electric wire and a terminal is covered with a protective layer having a water repellent layer having a fine concave-convex structure on a surface layer thereof and further having a water contact angle of 150° or larger (that is, having super water repellency). This protective layer (water repellent layer) comprises an aggregate of fine particles, and becomes to have super water repellency by that many micro spaces that are small to an extent such that water does not enter (in other words, an air layer) are formed in a fine concave-convex structure of the surface layer. As a result, water is difficult to enter a connecting part between a conductor of an electric wire and a terminal, and even through a conductor of an electric wire and a terminal are formed of different materials (even through dissimilar metal connection), corrosion in a connecting part can be prevented.

Furthermore, the protective layer (water repellent layer) exhibits the function of shielding water due to a structure and the like of the surface layer as described above. For this reason, even though the protective layer (water repellent layer) has small thickness as compared with a sealing material for water cutoff of the conventional product, water can be sufficiently prevented from entering a connecting part. For example, when a dispersion having dispersed therein fine particles (for example, nanoparticles) capable of forming a water repellent layer is applied to a connecting part and then dried, a water repellent layer having a thickness smaller than that of the conventional product can be formed. As a result, corrosion resistance can be enhanced without substantially deteriorating adaptability to an object to which a terminal is attached (for example, cavity of a connector).

Therefore, the electric wire with a terminal having the above constitution can prevent corrosion in a connecting part between a conductor of an electric wire and a terminal while maintaining adaptability to an object to which a terminal is attached.

The fine particles constituting a water repellent layer may be any fine particles so long as those are fine particles that can form many micro spaces that are small to an extent such that water does not enter (an air layer) in a fine concave-convex structure of the surface layer, and its constituent material, particle shape, grain shape and the like are not particularly limited. Examples of the fine particles constituting a water repellent layer include polytetrafluoroethylene fine particles having an average particle diameter of 200 to 8,000 nm and granular silica having an average particle diameter of 10 to 5,000 nm. The average particle diameter used is, for example, a particle diameter at integrated value 50% in particle size distribution obtained by a laser diffraction scattering method, or an average primary grain shape measured using a scanning electron microscope or a transmission electron microscope.

From the standpoint of enhancement of durability of a protective layer, the connecting part between an electric wire and a terminal may be covered with a primer layer and additionally a water repellent layer (aggregate of fine particles) may be formed on the primer layer. Thus, when the primer layer has been provided, adhesion of the water repellent layer to the connecting part is enhanced as compared with the case of forming the water repellent layer so as to cover the connecting part. As a result, peeling or the like of the protective layer (water repellent layer) can be surely prevented, thereby corrosion resistance is further enhanced.

According to the aspect (2), a conductor of an electric wire comes into contact with a terminal (specifically, a plating layer on the surface of a terminal) comprising a material different from a material of the conductor in the connecting part. That is, dissimilar metal connection is formed in the connecting part.

In an aspect (3), a method for manufacturing an electric wire with a terminal including an electric wire and a terminal electrically connected to the electric wire, the method includes electrically connecting a conductor of the electric wire to the terminal made of a material different from a material of the conductor, and forming a protective layer covering a connecting part between the conductor and the terminal, the protective layer having a water repellent layer having a fine concave-convex structure formed by an aggregate of fine particles on a surface layer thereof and having a contact angle to water of 150° or larger.

According to the aspect (3), similar to the aspect (1), a connecting part between a conductor of an electric wire and a terminal is covered with a protective layer having a water repellent layer having a fine concave-convex structure on a surface layer thereof and further having a water contact angle of 150° or larger (that is, having super water repellency).

This protective layer (water repellent layer) comprises an aggregate of fine particles, and becomes to have super water repellency by that many micro spaces that are small to an extent such that water does not enter (in other words, an air layer) are formed in the fine concave-convex structure of the surface layer. That is, the protective layer (water repellent layer) exhibits the function of shielding water due to a structure and the like of the surface layer as described above. For this reason, even though the protective layer (water repellent layer) has small thickness as compared with a sealing material for water cutoff of the conventional product, water can be sufficiently prevented from entering a connecting part.

As a result, water is difficult to enter the connecting part between a conductor of an electric wire and a terminal, and even through a conductor of the electric wire and the terminal comprise different materials (even through dissimilar metal connection), corrosion in the connecting part can be prevented. Furthermore, corrosion resistance can be enhanced without substantially deteriorating adaptability to an object to which a terminal is attached (for example, cavity of a connector).

Therefore, according to the method for manufacturing an electric wire with a terminal having the above constitution, corrosion resistance in the connecting part between a conductor of the electric wire and the terminal can be prevented while maintaining adaptability to an object to which a terminal is attached.

Similar to the aspect (2), in the step of forming a protective layer, the primer layer may be formed so as to cover the connecting part and additionally a water repellent layer (aggregate of fine particles) may be formed so as to cover the primer layer. Thus, when the primer layer has been provided, adhesion of the water repellent layer to the connecting part is enhanced as compared with the case of forming the water repellent layer so as to directly cover the connecting part. As a result, peeling or the like of the protective layer (water repellent layer) can be surely prevented, thereby corrosion resistance is further enhanced.

In an aspect (4), wire harness may include the electric wire with the terminal.

According to the aspect (4), similar to the aspect (1) or (2), the connecting part between a conductor of an electric wire and a terminal is covered with a protective layer having a water repellent layer having a fine concave-convex structure on a surface layer thereof and further having a water contact angle to water of 150° or larger (that is, having super water repellency). This protective layer (water repellent layer) comprises an aggregate of fine particles, and becomes to have super water repellency by that many micro spaces that are small to an extent such that water does not enter (in other words, an air layer) are formed in the fine concave-convex structure of the surface layer. That is, the protective layer (water repellent layer) exhibits the function of shielding water due to a structure and the like of the surface layer. For this reason, even though the protective layer (water repellent layer) has small thickness as compared with the sealing material for water cutoff of the conventional product, water can be sufficiently prevented from entering the connecting part.

As a result, water is difficult to enter the connecting part between a conductor and a terminal, and therefore, even through the conductor of an electric wire and the terminal comprise different materials (even through dissimilar metal connection), corrosion in the connecting part can be prevented. Furthermore, corrosion resistance can be enhanced without substantially deteriorating adaptability to an object to which a terminal is attached (for example, cavity of a connector).

Therefore, according to the wire harness having the above constitution, it is possible to prevent corrosion in the connecting part between a conductor of an electric wire and a terminal while maintaining adaptability to an object to which a terminal is attached.

### Advantageous Effects of the Invention

According to one or more embodiments, corrosion of a conductor of an electric wire can be prevented while maintaining design freedom of a shape of a terminal and adaptability to an object to which a terminal is attached.

The details of one or more embodiments will be further clarified by reading through mode for carrying out as described below by reference to the attached drawings.

### BRIEF DESCRIPTION OF THE DRAWINGS

FIG. 1 is a schematically perspective view of an electric wire with a terminal according to the present embodiment.

FIGS. 2A to 2C are views explaining a method for manufacturing the electric wire with a terminal shown in FIG. 1. FIG. 2A shows the state (before connection) that an electric wire has been separated from a terminal, FIG. 2B shows the state that an electric wire has been connected to a terminal, and FIG. 2C shows the state that a protective layer (water repellent layer) has been formed so as to cover a connecting part between a conductor of an electric wire and a terminal.

FIG. 3 is an A-A cross-sectional view in FIG. 2C.

FIGS. 4A and 4B are schematic views explaining a surface state of a protective layer (water repellent layer). FIG. 4A is an enlarged view of a surface of a protective layer (water repellent layer), and FIG. 4B is a schematic view showing the relationship between a surface of a protective layer (water repellent layer) and water droplets.

### DETAILED DESCRIPTION

Exemplary embodiments are described with reference to the drawings.

### <Structure>

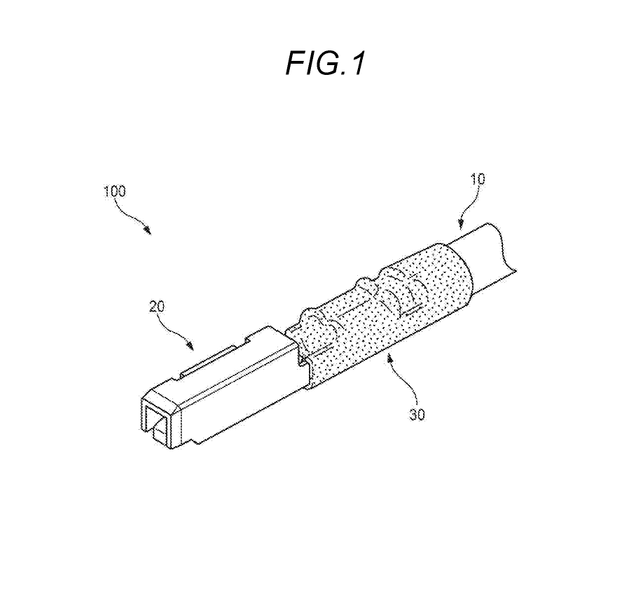

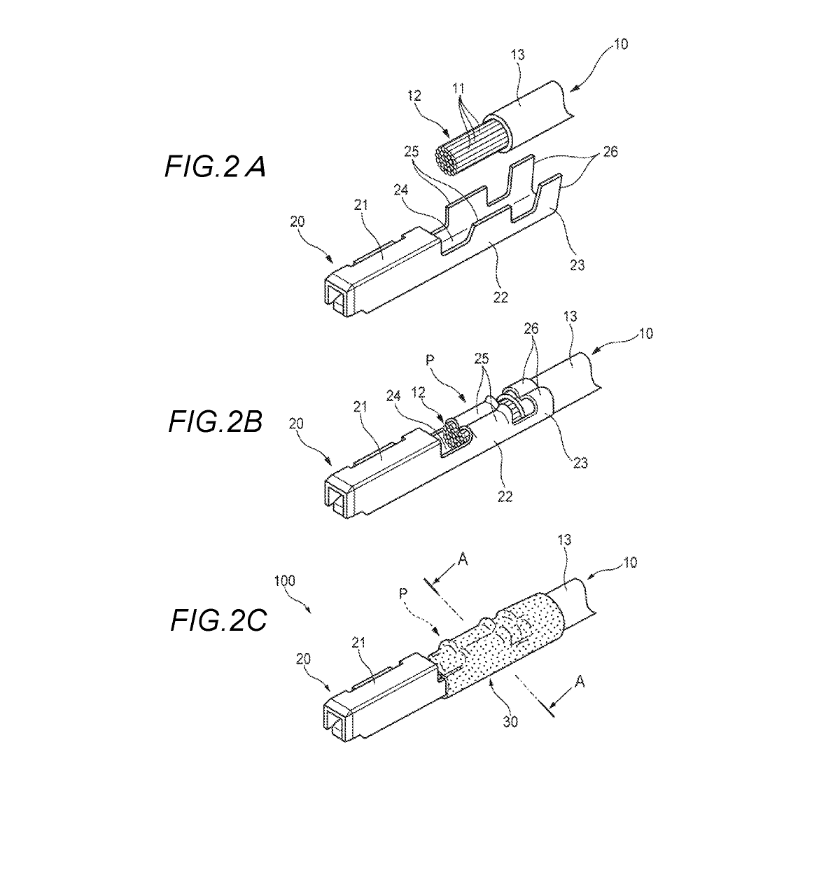

As shown in FIG. 1, an electric wire 100 with a terminal according to one embodiment of the present invention comprises an electric wire 10, a terminal 20 press-bonded to an end of the electric wire 10, and a protective layer 30 covering a connecting part between the electric wire 10 and the terminal 20. The detailed structures and the like of those members are described below by reference to a method for manufacturing the electric wire 100 with a terminal shown in FIGS. 2A to 2C.

As shown in FIG. 2A, the electric wire 10 has a conductor 12 comprising twisted plural strands 11 comprising an aluminum material. The conductor 12 is covered with an insulating coating 13 comprising an insulating resin. FIG. 2A shows the state that the insulating coating 13 is peeled at an end of the electric wire 10 and the conductor 12 is exposed.

The aluminum material used in the conductor 12 may be generally industrial pure aluminum and may be an aluminum alloy comprising aluminum and other additive elements (Fe, Mg and the like) added thereto. The aluminum material is appropriately selected considering weight, strength, durability and the like required in the conductor 12 and is not particularly limited.

The terminal 20 is a female terminal and comprises a box-shaped part 21 in which a mating male terminal (not shown) is inserted, a conductor press-bonding part 22 provided backward from the box-shaped part 21 in a longitudinal direction, and an electric wire fixing part 23 provided backward from the conductor press-bonding part 22 in a longitudinal direction. The box-shaped part 21, the conductor press-bonding part 22 and the electric wire fixing part 23 are integrally formed. The terminal 20 comprises copper or a copper alloy as a base material, and a plating layer of tin, gold or silver provided on the surface of the base material. The terminal 20 is not always necessary to be a female terminal, and may be other terminal (for example, a male terminal).

As shown in FIG. 2A, the conductor press-bonding part before being press-bonded to the electric wire 10 (specifically, the conductor 12) comprises a terminal bottom 24 and a pair of conductor caulking pieces 25 extending in an obliquely outer upper side from both sides in a width direction of the terminal bottom 24. Similarly, the electric wire fixing part 23 before being press-bonded comprises a terminal bottom common to the terminal bottom 24 of the conductor press-bonding part 22, and a pair of coating caulking pieces 26 extending in an obliquely outer upper side from both sides in a width direction of the terminal bottom 24.

As shown in FIG. 2B, the conductor 12 is inserted between the conductor caulking pieces 25 so as to become in contact with the terminal bottom 24, and the conductor caulking pieces 25 are then caulked so as to hold the circumference surface of the conductor 12 from both right and left sides. Thus, the conductor 12 of the electric wire 10 is electrically connected to the terminal bottom 24 and conductor caulking pieces 25 of the terminal 20. In other words, the conductor 12, the terminal bottom 24 and the conductor caulking pieces 25 (that is, the conductor press-bonding part 22) constitutes a connecting part P between the electric wire 10 and the terminal 20.

The coating caulking pieces 26 are caulked so as to hold the circumference surface of the insulating coating 13 from both right and left sides, and the coating caulking pieces 26 are fixed to the insulating coating 13. Thus, the electric wire 10 is inseparably connected to the terminal 20.

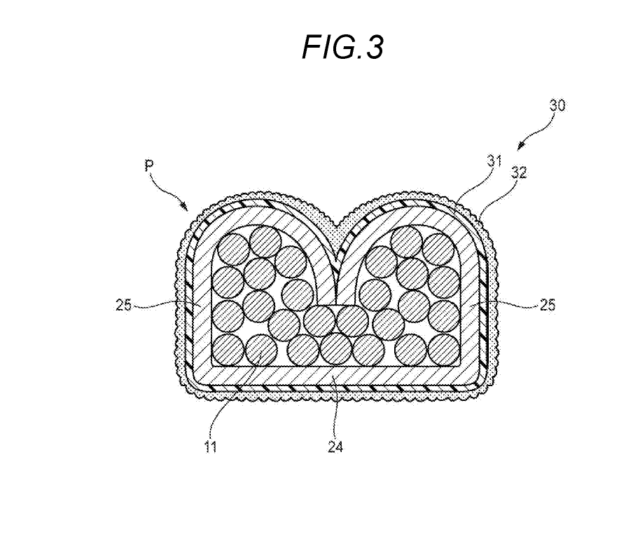

As shown in FIG. 2C, the protective layer 30 is formed so as to cover the connecting part P. In this example, the protective layer 30 is formed so as to cover the coating caulking pieces 26 in addition to the connecting part P. For convenience, a place having the protective layer 30 formed thereon (a place corresponding to the connecting part P and the coating caulking pieces 26 in FIGS. 2A to 2C) is hereinafter called a “covering place”. The protective layer 30 may be directly formed on the covering place and may be formed between the covering place and the protective layer 30 such that a primer layer (the detail is described hereinafter) is sandwiched between those. Specifically, when the primer layer has been used, the protective layer 30 comprises the primer layer 31 formed so as to cover the connecting part P (the terminal bottom 24 and the conductor caulking pieces 25 in the cross-sectional view of FIG. 3) and the water repellent layer 32 formed so as to cover the primer layer 31, as shown in the cross-sectional view of FIG. 3. On the other hand, when the primer layer is not used, the protective layer 30 comprises only the water repellent layer 32.

The primer layer 31 is formed by, for example, applying a liquid material for constituting the primer layer 31 to the covering place (the connecting part P and the like) and hardening the liquid material. Example of a resin that can be used as the primer layer 31 specifically includes at least one of vinyl acetate, an amine resin, an acryl resin, a phenol resin, a silicone-modified acryl resin, a vinylidene chloride resin, a vinyl chloride resin, an epoxy resin, a urethane resin, an acryl urethane resin, a silicone resin, a fluorine resin, a polyester resin and a polyolefin resin.

The water repellent layer 32 is formed by, for example, applying (or jetting by a spray or the like) a dispersion having dispersed therein fine particles for constituting the water repellent layer 32 to the primer layer 31 so as to cover the primer layer, and then drying the dispersion. Examples of the fine particles used in the water repellent layer 32 specifically include at least either of organic particles and inorganic particles. Examples of the organic particles include fluorine-containing synthetic resins such as polytetrafluoroethylene (PTFE), a perfluoroalkoxy resin (PFA), an ethylene tetrafluoroethylene resin (ETFE) resin and polyvinylidene fluoride; thermoplastic resins such as polyethylene and vinyl chloride; thermosetting resins such as a urea resin, a phenol resin and a silicone resin; and engineering plastics such as a polyamide resin, an acryl resin, a urethane resin, polycarbonate and a polymer alloy. The organic particles are preferably insoluble in an organic solvent. Examples of the inorganic particles include at least one of an oxide of anyone of silicon, tin, titanium, aluminum, zirconium, cerium, antimony, magnesium, calcium and zinc, and carbon.

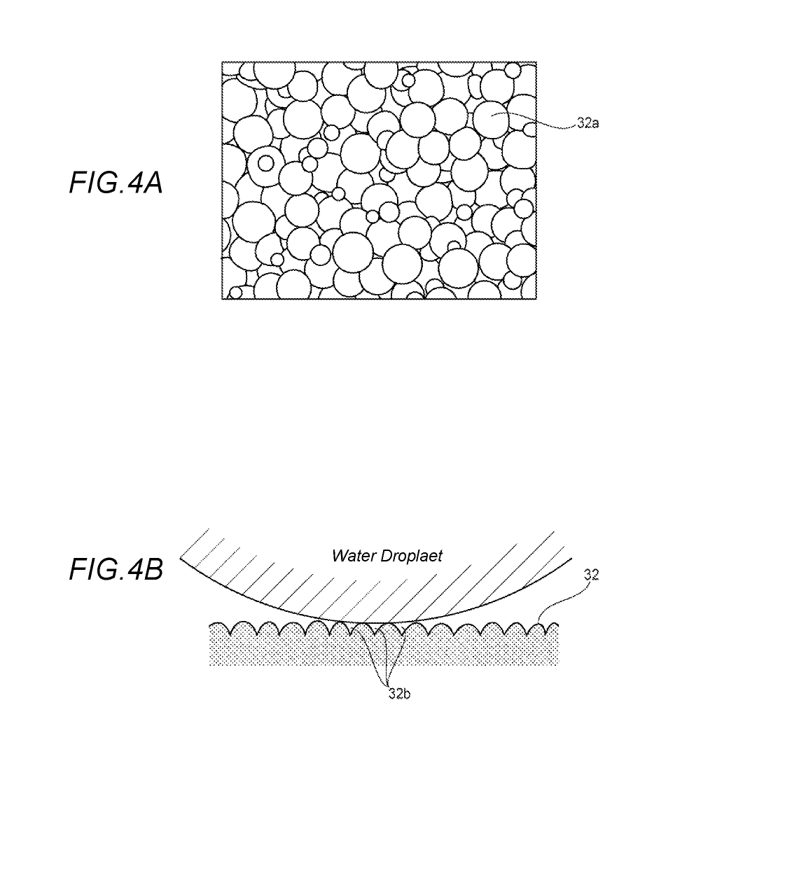

As shown in FIG. 4A, the water repellent layer 32 is a lamellar body comprising a laminate of aggregates of many fine particles 32a. Because the water repellent layer 32 has such a structure, as shown in FIG. 4B, a fine concave-convex structure is formed on its surface layer and additionally many micro spaces 32b small to an extent such that water does not enter (in other words, an air layer) are formed in the fine concave-convex structure of the surface layer. Furthermore, due to the fine concave-convex structure formed on the surface layer of the water repellent layer 32, a contact angle of water to the surface of the water repellent layer 32 is 150° or larger. In other words, the water repellent layer 32 has super water repellency. For this reason, even though water tries to enter toward the connecting part P from the outside, the water is repelled (shielded) by the surface layer of the water repellent layer 32, and the water cannot enter the connecting part P. The water repellent layer 32 has super water repellency due to the fine concave-convex structure. However, from the standpoint of enhancement of durability of the water repellent layer 32, it is preferred that fine particles themselves contained in the water repellent layer 32 have water repellency. Examples of the fine particles include fine particles formed from a fluorine-containing synthetic resin and a silicone resin.

The contact angle described above is a value obtained by quantifying the degree of wetting on the surface of an object, and can be defined as “an angle between a liquid surface and a solid surface in a place where a free surface of a quiescent liquid comes into contact with a solid wall (an angle inside a liquid)”.

The electric wire 100 with a terminal having the above constitution can be used as an electric wire constituting a wire harness. Specifically, for example, an electric wire with a connector is constituted by inserting the terminal 20 of the electric wire 100 with a terminal in a cavity of a connector (not shown), and various members (for example, corrugated tube, a protector and a grommet) containing the electric wire with a connector are combined, thereby constituting a wire harness.

### <Evaluation>

Evaluation of corrosion resistance of the electric wire 100 with a terminal is described below.

The experiments were conducted to evaluate corrosion resistance of the electric wire 100 with a terminal. Specifically, a plurality of samples (electric wires 100 with a terminal) shown in Table 1 were prepared according to the procedures described hereinafter.

Specifically, as described by reference to FIGS. 2A and 2B, the terminal 20 (base material: copper alloy, surface layer: tin plating) was electrically connected to the electric wire 10 (conductor 12: aluminum alloy, insulating coating 13: polyvinyl chloride). As shown in FIG. 2C and FIG. 3, the primer layer 31 (material: epoxy resin, thickness: see Table 1) was formed on the covering place (the connecting part P and the like), and the water repellent layer 32 (material: see Table 1, thickness: see Table 1) was then formed on the primer layer 31.

The primer layer 31 was formed by applying a material constituting the primer layer 31 to the covering place by the conventional spray coating method, and then drying the material at ordinary temperature for 30 minutes. The water repellent layer 32 was formed by applying a constituent material shown in Table 1 to the primer layer by the conventional spray coating method, and then drying the material at ordinary temperature for 60 minutes.

The constituent materials used for forming the water repellent layer 32 were HIREC 100 (registered trademark) manufactured by NTT Advance Technology Corporation, NeverWet manufactured by King Industries, Inc., FLUOROSURF (registered trademark) manufactured by Fluoro Technology, and NOXBARRIER (registered trademark) manufactured by NOK Corporation, as shown in Table 1.

Of the above constituent materials, when HIREC 100 (registered trademark) is used, the water repellent layer 32 comprising polytetrafluoroethylene particles having an average particle diameter of 200 to 8,000 nm fixed by a fluorine type silicone resin is formed. As a result of observation and the like by the present inventors, it is confirmed that the water repellent layer 32 has a fine concave-convex structure on the surface thereof. On the other hand, of the above constituent materials, when the water repellent layer 32 is formed using NeverWet, FLUOROSURF (registered trademark) and NOXBARRIER (registered trademark), it is confirmed that a fine concave-convex structure is not formed on the surface of the water repellent layer 32.

The contact angle of the water repellent layer 32 to water was measured in the samples (the electric wires 100 with a terminal) thus prepared. Furthermore, corrosion resistance was measured in each sample.

The contact angle to water was measured as a contact angle just after dropping about 1 μl of water droplet to the surface of the water repellent layer 32 of each sample from a microsyringe, using a contact angle gauge.

Corrosion evaluation test (elution test of aluminum ion) was conducted for the evaluation of corrosion resistance. Specifically, each sample (the electric wire 100 with a terminal) as a cathode and a copper electrode as an anode were dipped in 100 ml of salt water having a concentration of 5%, and a voltage of 10V was applied between those for 150 seconds. Thereafter, the amount of an aluminum ion eluted in the salt water was measured by an ICP atomic emission spectroscopy. As a result of the measurement, the case that the amount of aluminum eluted is 0.1 ppm or less was evaluated as “A”, and the case that the amount of aluminum eluted is more than 0.1 ppm was evaluated as “B”.

The test results are shown in Table 1 below. In Table 1, samples shown by Sample Nos. 1 and 2 correspond to the examples, and samples shown by Sample Nos. 3 to 5 correspond to the comparative examples.

TABLE 1

| Sample No. | 1 | 2 | 3 | 4 | 5 |
|---|---|---|---|---|---|
| Constituent material of water | HIREC100 | HIREC100 | NeverWet | FLUOROSURF | NOXBARRIER |
| repellent layer | | | | FG-3020C-20 | |
| Thickness of water repellent | 30 | 30 | 35 | 5 | 5 |
| layer (μm) | | | | | |
| Primer layer | Presence | None | Presence | None | None |
| Thickness of primer layer (μm) | 30 | — | 35 | — | — |
| Fine concave-convex structure | Presence | Presence | None | None | None |
| Contact angle to water (°) | 150 | 150 | 110 | 110 | 110 |
| Corrosion resistance evaluation | A | A | B | B | B |

As shown in Table 1, as a result of the test, it was confirmed that when the contact angle of the water repellent layer 32 to water is smaller than 150° as in Sample Nos. 3 to 5 (comparative examples), sufficient corrosion resistance is not obtained (evaluation B) regardless of the presence or absence of the primer layer.

On the other hand, it was confirmed that when the contact angle of the water repellent layer 32 to water is 150° and the fine concave-convex structure is present on the surface of the water repellent layer 32 as in Sample Nos. 1 and 2 (examples), sufficient corrosion resistance is obtained (evaluation A).

It was clarified from the above test results that when a covering place (the connecting part P and the like) is covered with the protective layer 30 having the water repellent layer 32 having a fine concave-convex structure on the surface thereof and further having a contact angle to water of 150° or larger (that is, having super water repellency), even though the conductor 12 of the electric wire 10 and the terminal 20 are formed from different materials (dissimilar metal connection), corrosion of the connecting part P can be prevented. Therefore, when the water repellent layer 32 as above is used, water can be sufficiently prevented from entering the connecting part P even though the thickness of the protective layer 30 (water repellent layer 32) is small as compared with a sealing material for water cutoff of the conventional product.

Therefore, the electric wire 100 with a terminal according to the embodiment of the present invention can prevent corrosion in the connecting part P between the conductor 12 of the electric wire 10 and the terminal 20 without substantially deteriorating adaptability to an object to which the terminal 20 is attached (for example, cavity of a connector).

When the covering place is covered with the primer layer 31 and the water repellent layer 32 is formed on the primer layer 31, adhesion of the water repellent layer 32 to the covering place can be enhanced as compared with the case of forming the water repellent layer 32 so as to directly cover the covering place. Thus, when the primer layer 31 is provided, the protective layer 30 (water repellent layer 32) can be further surely prevented from peeling, and corrosion resistance is further enhanced.

The present invention is not limited to the above each embodiment, and can use various modifications within the scope of the present invention. For example, the present invention is not limited to the above-described embodiment, and modifications, improvements and the like can be appropriately made. Material, shape, size, number, arrangement place and the like of each constituent element in the above embodiment are optional so long as the present invention can be achieved, and are not limited.

The characteristics of the embodiments of the electric wire with a terminal, the method for manufacturing an electric wire with a terminal and the wire harness according to the present invention are briefly and collectively described in the following (1) to (4).

(1) An electric wire (100) with a terminal comprising:

an electric wire (10);

a terminal (20) electrically connected to the electric wire; and

a protective layer (30) covering a connecting part (P) between the electric wire and the terminal,

wherein the terminal (20) is made of a material different from a material of a conductor of the electric wire in the connecting part (P), and

wherein the protective layer (30) includes a water repellent layer (32) having a fine concave-convex structure formed by aggregates of fine particles on a surface layer thereof and having a contact angle to water of 150° or larger.

(2) The electric wire with the terminal according to the above-described (1),

wherein the conductor (12) of the electric wire is made of copper, aluminum or an aluminum alloy, and

wherein the terminal (20) includes a base material made of copper or a copper alloy, and a plating layer made of tin, gold or silver formed on a surface of the base material.

(3) A method for manufacturing an electric wire (100) with a terminal including an electric wire (10) and a terminal (20) electrically connected to the electric wire, the method comprising:

electrically connecting a conductor (12) of the electric wire to the terminal made of a material different from a material of the conductor, and

forming a protective layer (30) covering a connecting part (P) between the conductor and the terminal, the protective layer (30) having a water repellent layer (32) having a fine concave-convex structure formed by an aggregate of fine particles on a surface layer thereof and having a contact angle to water of 150° or larger.

(4) A wire harness comprising the electric wire with the terminal according to any one of the above-described (1) or (2).

### DESCRIPTION OF REFERENCE NUMERALS AND SIGNS

10 Electric wire
12 Conductor
20 Terminal
30 Protective layer
31 Primer layer
32 Water repellent layer
P Connecting part
100 Electric wire with terminal

What is claimed is:

1. An electric wire with a terminal comprising:
an electric wire;
a terminal electrically connected to the electric wire; and
a protective layer covering a connecting part between the electric wire and the terminal,
wherein the terminal is made of a material different from a material of a conductor of the electric wire in the connecting part, and
wherein the protective layer includes a water repellent layer having a fine concave-convex structure formed by aggregates of fine particles on a surface layer thereof and having a contact angle to water of 150° or larger.

2. The electric wire with the terminal according to claim 1,
wherein the conductor of the electric wire is made of copper, aluminum or an aluminum alloy, and
wherein the terminal includes a base material made of copper or a copper alloy, and a plating layer made of tin, gold or silver formed on a surface of the base material.

3. A method for manufacturing an electric wire with a terminal including an electric wire and a terminal electrically connected to the electric wire, the method comprising:
electrically connecting a conductor of the electric wire to the terminal made of a material different from a material of the conductor, and
forming a protective layer covering a connecting part between the conductor and the terminal, the protective layer having a water repellent layer having a fine concave-convex structure formed by an aggregate of fine particles on a surface layer thereof and having a contact angle to water of 150° or larger.

4. A wire harness comprising the electric wire with the terminal according to claim 1.
